(19) United States
(12) Patent Application Publication
(10) Pub. No.: US 2020/0202282 A1
(43) Pub. Date: Jun. 25, 2020

(54) SYSTEM AND METHOD FOR CALCULATING AVAILABILITY POINTS FOR WORKFORCE SCHEDULING

(71) Applicant: Nice Ltd., Ra'anana (IL)

(72) Inventors: Kalyani Jyotii CHENNUPATI, Coppell, TX (US); Charles William GULLEDGE, Richardson, TX (US); Muneeb S. AHMAD, Plano, TX (US)

(73) Assignee: Nice Ltd., Ra'anana (IL)

(21) Appl. No.: 16/228,862

(22) Filed: Dec. 21, 2018

(51) Int. Cl. G06Q 10/06; G06Q 10/10

(52) U.S. Cl. CPC G06Q 10/063116; G06Q 10/109; G06Q 10/0633; G06Q 10/063112

(57) ABSTRACT

A system and method for calculating availability points for workforce scheduling, including obtaining past workloads per past time intervals; calculating, for each future time interval of a set of future time intervals, a workforce requirement based on the past workloads; obtaining, for each worker of a group of workers, an availability to work at the future time intervals; calculating availability points for each of the future time intervals, based on the workforce requirement and the availability of each worker of the group of workers; presenting the availability points per the future time intervals to each of the workers; and obtaining the desired time intervals from the workers.

### FIELD OF THE INVENTION

Embodiments of the invention relate to technology for calculating availability points for workforce scheduling, for example, for scheduling agents in contact centers.

### BACKGROUND OF THE INVENTION

Arranging shifts for workforce in an organization, such as agents in a contact center (also referred to herein as a call center), may not be an easy task. In many organizations, the workers provide the time intervals (time increments of a predetermined length, e.g., 15, 20 or 30 minutes, also referred to herein as time slots or time periods) or the shifts they wish to take, and the supervisor has to arrange shifts according to the business requirements and the workforce preferences. Frequently, however, some time slots are requested by many workers, while other time slots, that are less convenient, are not desired by workers. In many organizations the solution to this problem is to assign some rating or score, such as availability points, to each time slot. As used herein, availability points may refer to a score, a grade or a rank that may be given to or associated with a time slot and may indicate the easiness or difficulty of staffing that time slot. For example, working hours of an organization may be divided into times slots of, for example half an hour. Each time slot may be given or associated with availability points or another rating that may indicate how hard or easy it is to staff that time slot. For example, a time slot that is difficult to staff or fill may be associated with a higher number of availability points than time slots that are easy to staff.

The availability points may be presented to the workforce, e.g., in a dedicated graphical user interface (GUI) of a dedicated application. Each worker may select time slots in which he or she are interested to work, up to a required level of aggregated availability points. Thus, reaching the required level of aggregated availability points may be achieved by selecting more time slots with lower availability points or less time slots with higher availability points. This may encourage workers to select unpopular time slots (e.g., time slots with high level of availability points), since if scheduled for these time slots, they will have to work less hours.

Thus, supervisors are required to enter availability points for each time slot of each period in the day and for each day of the week and month. The problem is, however, that supervisors do not know what are the realistic availability points for the various time slots. Thus, currently, the availability points are determined mainly based on guesswork and gut feeling of supervisors.

### SUMMARY

According to embodiments of the invention, there is provided a system and method for calculating availability points for workforce scheduling. Embodiments of the invention may include: obtaining past workloads per past time intervals; calculating, for each future time interval of a set of future time intervals, a workforce requirement based on the past workloads; obtaining, for each worker of a group of workers, an availability to work at the future time intervals; calculating availability points for each of the future time intervals, based on the workforce requirement and the availability of each worker of the group of workers; presenting the availability points per the future time intervals to each of the workers; and obtaining the desired time intervals from the workers.

According to embodiments of the invention, calculating the workforce requirement may include calculating an expected requirement value (R) for the future time interval as an average number of workers that were required to work in at least one past time interval that is analogous to the future time interval, and wherein calculating the availability points may include: for each future time interval: calculating an expected staffing value (S) as the number of workers that were scheduled for the past time interval that is analogous to the future time interval; calculating a net staffing (net_S) ratio as for example:

$$net\_S = \frac{S - R}{S + R} ,$$

calculating a level of interest (I) for the future time interval as a maximum value of one and the number of workers that declared their availability to work in the future time interval; calculating an incentive factor (F) for the future time interval as for example:

$$F = \frac{R * net\_S}{I} ,$$

calculating an incentive factor range (range_F) as the difference between a maximum incentive factor across all the future time intervals (max_F) and a minimum incentive factor across all the future time intervals (min_F); calculating the availability points (P) as for example:

$$P = A + \frac{F - min\_F}{range\_F} * B ,$$

where A and B are tuning parameters.

According to embodiments of the invention, the past time interval that is analogous to the future time interval may include past time intervals of a same time of day and day of week as the future time interval.

According to embodiments of the invention, the group of workers may be a group of agents in a call center.

According to embodiments of the invention, the availability points per the future time intervals may be presented to each of the workers in an application that enables the worker to enter desired time intervals based on the associated availability points.

Embodiments of the invention may include assigning agents to the future time intervals based on the desired time intervals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system, according to embodiments of the invention;

FIG. 2 schematically illustrates a top-level design of a system for scheduling agents in a call center, according to embodiments of the invention;

FIG. 3 is a flowchart of a method for workforce scheduling, according to embodiments of the present invention;

FIG. 4 is a flowchart of a method for calculating availability points for workforce scheduling, according to embodiments of the present invention;

FIG. 5 shows an example of a GUI, according to embodiments of the invention; and

FIG. 6 is a high-level block diagram of an exemplary computing device, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention pertain, inter alia, to the technology of a workforce (e.g., human agents) scheduling in an organization (e.g., a call center, customer service center, or another organization not including agents or telephone customer service). Embodiments may provide an improvement to workforce scheduling technology for any suitable organization by for example improving and automating the calculation of a rating or score assigned to time slots, such as availability points. Embodiments of the invention provide unique method to estimate a score such as availability points based on past data and workforce preferences, thus providing realistic availability points that may be closely related to the actual difficulty of staffing each time interval or time slot, as opposed relying on guesswork and gut feeling of supervisors.

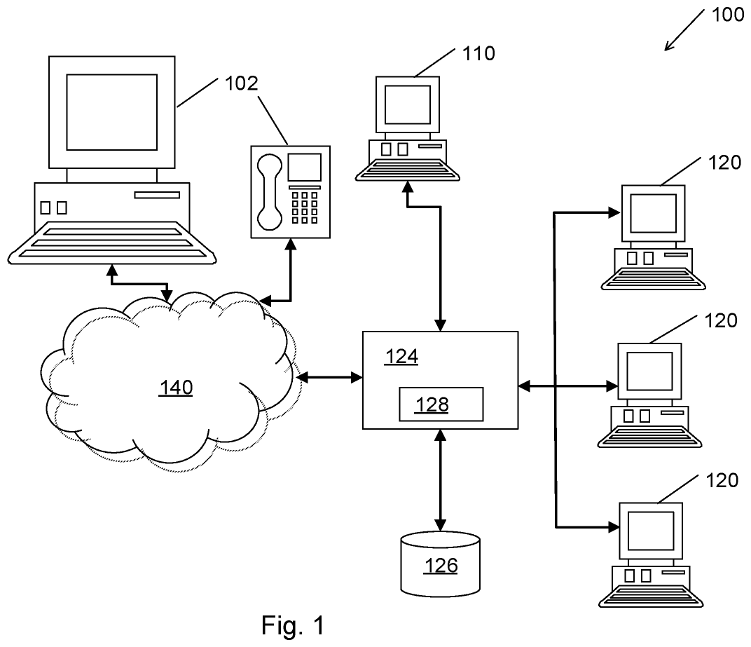

Reference is made to FIG. 1, which schematically illustrates a system 100, according to embodiments of the invention. System 100 may include contact center 124 to connect customer devices 102 to agent devices 120. Contact center 124 may also be connected to supervisor device 110. Contact center 124 may be or may include company call centers for telephone-based support, or online support forums for Voice over IP (VoIP) Internet-based support, for example, to provide customers with technical support, sell products, schedule appointments, or otherwise interact or communicate with customers; in other embodiments organizations other than contact centers or customer support centers may include embodiments of the invention, such as warehouses, delivery firms, brick-and-mortar retailers, etc. Contact center 124 may include a switching station or an automatic call distributor (ACD) 128 to order and connect each of a plurality of user devices 102 to one of a plurality of agent devices 120 at the same time. Contact center 124 may be connected to database 126 for storing interactions (e.g. conversations via telephone, VoIP, chat, etc.) between user devices 102 and agent's devices 120, and other data such as workloads at past time intervals, requirement of workers at future time intervals (e.g. not having yet occurred), preferences of workers, availability points, worker selections and any other relevant data. In some embodiments, real-time data from ACD 128 may be collected and stored in database 126. The collected real time data may later be used to calculate past workloads per past time intervals.

System 100 may be connected, or configured to be connected, to one or more user devices 102, such as, computers (for web or Internet voice connections), telephones (for telephone or radio network connections), for a customer to interact with and communicate with agents over one or more networks 140. Customers may use user devices 102 to connect to live agents, for example, using or operating on agent devices 120 at contact center 124. System 100 may be connected, or configured to be connected, to one or more supervisor devices 102, such as, a computer for supervising agents.

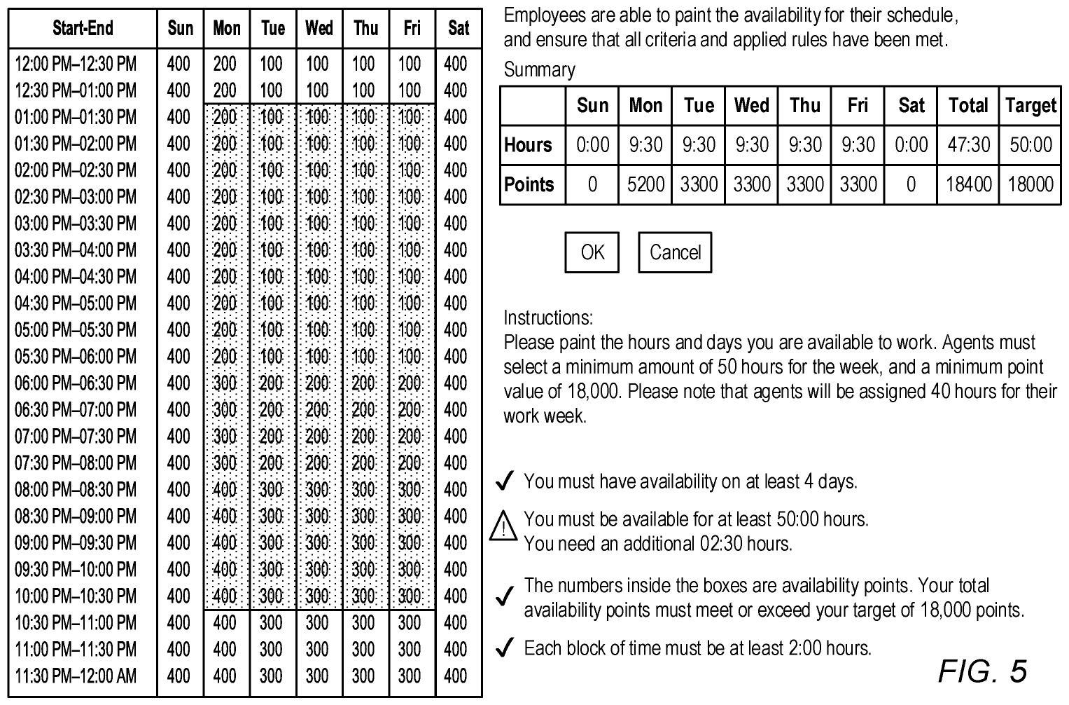

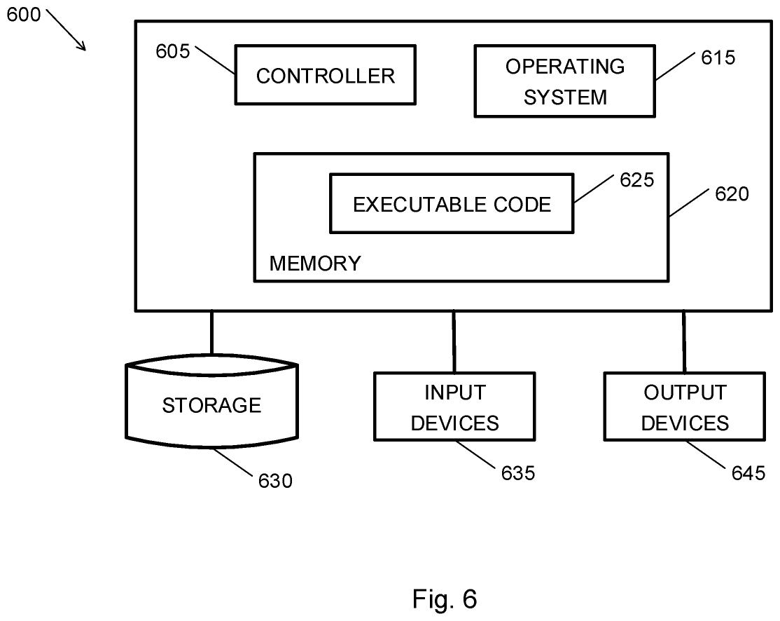

Each of user devices 102, supervisor device 110, contact center 124 and agent devices 120 may be or may include a computing device such as computing device 600 depicted in FIG. 6. Database 126 may be or may include a storage device such as storage device 630. Agent device 120 may include a display (such as output device 645) for displaying availability points to workers, for example as depicted in FIG. 5, and input devices (such as input device 635) for obtaining selection of time slots and other data from workers.

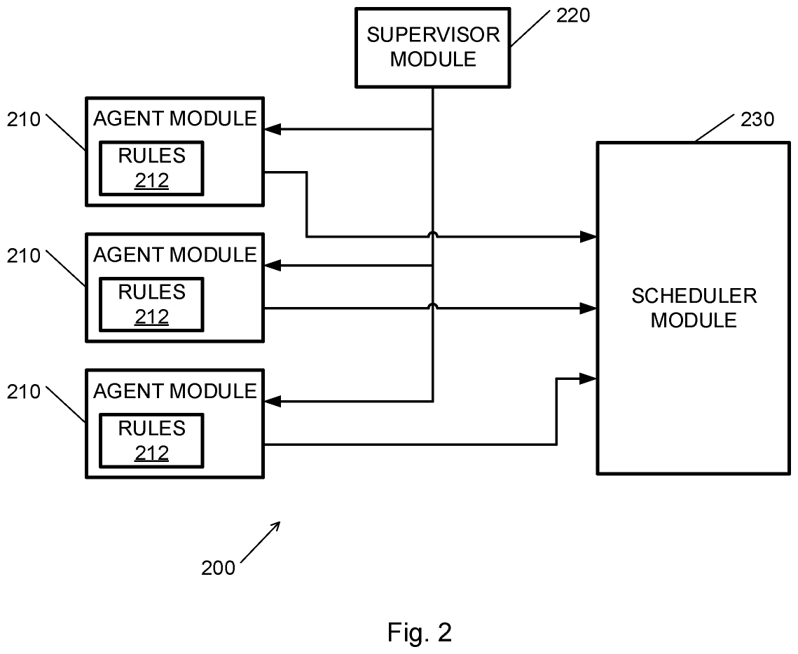

Reference is made to FIG. 2, which schematically illustrates a top-level design of a system 200 for scheduling agents in a call center, according to embodiments of the invention. It should be readily understood that the structure of system 200 depicted in FIG. 2 is demonstrative only and the functionality disclosed herein may be performed by other modules or structures. System 200 may include a plurality of agent modules 210 one or more supervisor modules 220, each connected to a subgroup of agent modules 210, and a scheduler module 220. The various modules may be for example processes executed for example by components of a system as shown in FIG. 1. For example, agent modules 210 supervisor modules 220 and scheduler module 230 may be partially or fully included in contact center 124. In some embodiments some or all of the functions of agent module 210 may be included in an agent device 120, and some or all of the functionalities of supervisor modules 220 may be included in supervisor module 220.

System 200 may include scheduler module 230 for calculating availability points and for scheduling agents shifts as disclosed herein. According to embodiments of the invention, scheduler module 230 may obtain or receive information regarding past workloads, e.g., the number of workers or agents required at past (e.g. having already occurred) time intervals or time slots. Scheduler module 230 may find or match one or more corresponding or equivalent past time intervals for future time intervals. Time intervals may correspond or be equivalent or analogous to past time intervals by time of day and day of week. For example, corresponding or equivalent time intervals may include time intervals of the same or substantially the same time of day and day of week of different weeks. Other factors may apply, for example the relative position of various days within a month or even a year, for example, near holidays. Thus, requirement for agents (e.g., the number of workers required) at a future time interval may be estimated based on the actual number of agents that were required to work in the one or more past time interval that is equivalent or analogous to the future time interval. Scheduler module 230 may obtain the availability or preference of a group of agents to work at future time intervals. For example, each agent may enter his or her availability or preferences to an agent module 210. Scheduler module 230 may obtain or receive the availability or preference of a group of agents to work at future time intervals from agent modules 210 of a group of agents. Scheduler module 230 may calculate availability points for future time intervals based on the estimated workload or workforce requirement (e.g., the number of workers required) and on the availability of each agent of the group of agents, as disclosed herein. The availability points for future time intervals may be presented to the agents, e.g., on a dedicated GUI (e.g., the GUI presented in FIG. 5), by for example, agent modules 210. Each agent may enter his or her desired time intervals based on the associated availability points, e.g., via the dedicated GUI of agent modules 210. Agent modules 210 may include rules 212 for checking the desired time intervals entered by the agents. For example, agent modules 210 may verify that the total availability points of each agents is above a threshold. Other rules 212 may be verified.

Scheduler module 230 may automatically or semi automatically schedule agents, or assign agents to time slots, based on their preferences and the requirements of the organization, as well as on other data. In some embodiments, when agents modify their availability, notifications may be sent to a supervisor that may activate automatic schedule generation based on the preferences of the agents. In some embodiments, automatic schedule generation may be automatically activated by scheduler module 230, e.g., when all agents in a defined group of workers have provided their availability. Automatic agents scheduling may be performed based on the preferences of the agents according to any applicable method. Embodiments of the invention may encourage agents to select time slots that are difficult to staff, and by this make automatic scheduling more feasible and efficient since more time slots would be selected by agents and not left empty.

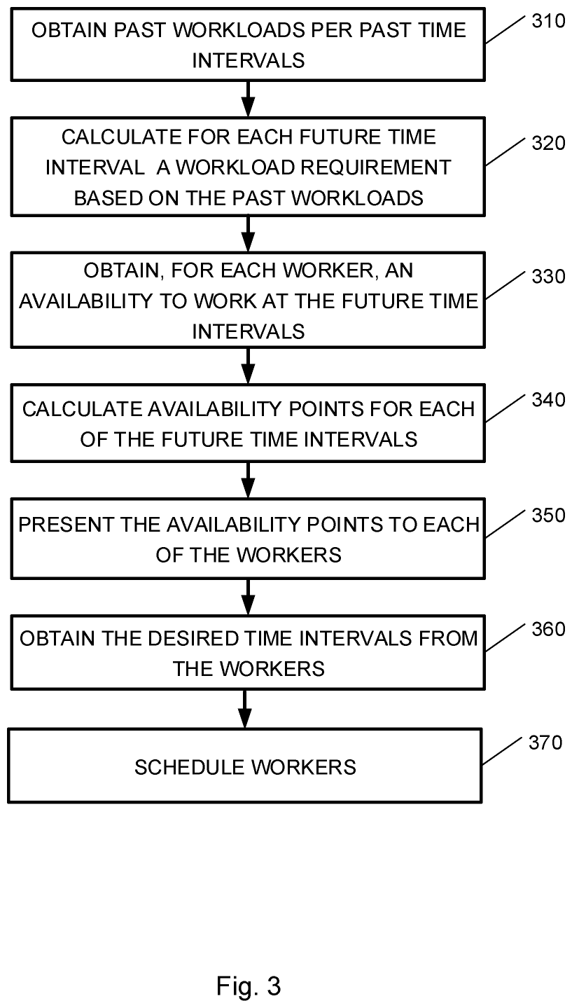

Reference is now made to FIG. 3 which is a flowchart of a method for workforce scheduling, according to embodiments of the present invention. The workforce may include agents in a call center or any other workforce that need to be assigned or scheduled in time periods or shifts. An embodiment of a method for calculating availability points for workforce scheduling may be performed, for example, by contact center 124 presented in FIG. 1 and/or system 200 depicted in FIG. 2, but other hardware may be used.

In operation 310 past workloads per past time intervals may be obtained. For example, data regarding past workloads per past time intervals may be collected and analyzed. In some embodiments, real-time data from an ACD (e.g., ACD 128) of the call center (e.g., call center 124) may be collected and stored in a database (e.g., database 126). The collected real time data may be used to calculate past workloads per past time intervals. In operation 320, a workload or workforce requirement may be calculated for each future time interval of a set of future time intervals based on the past workloads. For example, calculating a workforce reequipment for a future time interval may include calculating an expected requirement value, R, as the number of workers (e.g. people working at an organization) that were required to work in a past time interval that is similar to, analogous or equivalent to the future time interval or as an average number of workers that were required to work in each of a plurality of past time intervals that are equivalent or analogous to the future time interval. In operation 330, an availability to, or an offer to, work or be scheduled during the future time intervals may be obtained for each worker of a group of workers. In operation 340 availability points or another rating or score for each of the future time intervals may be calculated, based on the workforce requirement and the availability of each worker of the group of workers, as disclosed herein. In operation 350 the availability points or other rating per the future time intervals may be presented to each of the workers in an application that may enable the worker to enter desired time intervals based on the associated availability points. For example, workers may be required to reach a specified level of aggregated availability points and may reach the specified level of aggregated availability points by selecting more time slots with lower availability points or less time slots with higher availability points. In some organizations workers may be encouraged to select time slots with higher availability points by relating the hourly payment to the availability points. In operation 360 the desired time intervals may be obtained or received from the workers. In operation 370 workers may be automatically or semi automatically scheduled, e.g. assigned to time slots, according to their preferences and the future workforce requirement. In some embodiments, a supervisor may activate automatic schedule generation based on the preferences of the agents. In some embodiments, automatic schedule generation may be automatically activated e.g., when all agents in a defined group of workers have provided their availability.

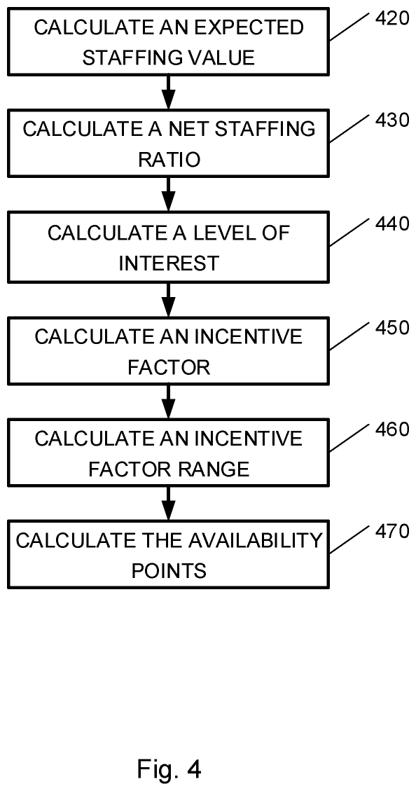

Reference is now made to FIG. 4 which is a flowchart of a method for calculating a rating or score such as availability points for workforce (e.g., human agents) scheduling, according to embodiments of the present invention. An embodiment of a method for calculating availability points for workforce scheduling may be an elaboration of operation 340 of the example method for workforce scheduling presented in FIG. 3, and may likewise be performed, for example, by contact center 124 presented in FIG. 1 and/or system 200 depicted in FIG. 2, but other hardware may be used. The operations of FIG. 4 may be repeated for each future time interval for which availability points need to be calculated. It should be readily understood that the embodiment presented in FIG. 4 is an example of calculating availability points, and that other methods may be used.

In operation 420 an expected staffing value, S, may be calculated as the number of workers that were scheduled for the past time interval or an average of the number of workers that were scheduled for the plurality of past time intervals that are equivalent or analogous to the future time interval. In operation 430, a net staffing ratio, net_S, may be calculated. The net staffing ratio may be for example a number ranging from −1 to 1 and representing the net staffing, e.g., the difference between staffing, S, and requirements, R, normalized by a fixed range irrespective of the magnitude of either. For example, the net staffing ratio, net_S, may be calculated by (other equations may be used):

$$net\_S = \frac{S - R}{S + R} \qquad ( Equation 1 )$$

In operation 440, a level of interest, I, may be calculated for the future time interval. The level of interest may be a measure of a declared preferences of workers to be scheduled or assigned at the future time interval. For example, the level of interest, I, may be calculated as a maximum value of one and the number of workers that declared their availability to work in the future time interval, M for example:

I=max(1, M) (Equation 2)

In operation 450, an incentive factor, F, may be calculated for the future time interval. The incentive factor, F, may be a measure of the relative requirement versus relative preference for workers to be available during a future time interval. For example, the incentive factor, F, may be calculated as for example:

$$F = \frac{R * net\_S}{I} \qquad ( Equation 3 )$$

In operation 460, an incentive factor range, range_F, may be calculated as the difference between a maximum incentive factor across all the future time intervals, max_F, and a minimum incentive factor across all the future time intervals, min_F for example:

range_F=max(F)−min(F) (Equation 4)

In operation 470, the availability points, P, may be calculated, for example, as:

$$P = A + \frac{F - min\_F}{range\_F} * B \qquad ( Equation 5 )$$

Where A and B are tuning parameters. For example, A may equal an arbitrary minimum value of the availability points, and B may equal a difference between a maximum value of availability points (again an arbitrary value larger than the selected minimum value) and the minimum value of availability points.

Reference is made to FIG. 5, showing an example of a GUI, according to embodiments of the invention. The GUI may be a part of a scheduling application or program, as disclosed herein. In this example, availability points range from 100 points for time slots that are easy to staff to 400 points for time slots that are difficult to staff. As can be seen, the availability points, for time slots or time intervals may be presented to workers and workers may select future time intervals in which they would like to be scheduled or assigned. For example, workers may input or insert their selected time intervals by, for example, typing their selected time slots, by marking these time intervals with a mouse, or using any other applicable method. The selected time intervals may be highlighted or painted on the screen so that the worker may have a clear visualization of his selections. The scheduling application may obtain the selection of the worker and may check if this selection conforms to a set of rules and criteria. For example, the application may verify that the aggregated or accumulated availability points of the worker reached or passed a required level of aggregated or accumulated availability points.

Reference is made to FIG. 6, showing a high-level block diagram of an exemplary computing device according to some embodiments of the present invention. Computing device 600 may include a processor or controller 605 that may be, for example, a central processing unit processor (CPU), a graphics processing unit (GPU), a chip or any suitable computing or computational device, an operating system 615, a memory 620, executable code 625, storage or storage device 630, input devices 635 and output devices 645. Controller 605 may be configured to carry out methods described herein, and/or to execute or act as the various modules, units, etc., for example by executing code or software. More than one computing device 600 may be included. Multiple processes discussed herein may be executed on the same controller. For example, contact center 124 presented in FIG. 1, and agent module 210, supervisor module 220 and scheduler module 230 presented in FIG. 2 may be implemented by one or more controllers 605.

Operating system 615 may be or may include any code segment (e.g., one similar to executable code 625 described herein) designed and/or configured to perform tasks involving coordination, scheduling, arbitration, supervising, controlling or otherwise managing operation of computing device 600, for example, scheduling execution of software programs or enabling software programs or other modules or units to communicate. Operating system 615 may be a commercial operating system.

Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different memory units. Memory 620 may be a computer or processor non-transitory readable medium, or a computer non-transitory storage medium, e.g., a RAM.

Executable code 625 may be any executable code, e.g., an application, a program, a process, task or script. Executable code 625 may be executed by controller 605 possibly under control of operating system 615. For example, executable code 625 may be an application that when executed calculates availability points as further described herein. Although, for the sake of clarity, a single item of executable code 625 is shown in FIG. 6, a system according to embodiments of the invention may include a plurality of executable code segments similar to executable code 625 that may be loaded into memory 620 and cause controller 605 to carry out methods described herein. For example, units or modules described herein may be, or may include, controller 605 and executable code 625.

Storage device 630 may be any applicable storage system, e.g., a disk or a virtual disk used by a VM. Storage 630 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content or data may be stored in storage 630 and may be loaded from storage 630 into memory 620 where it may be processed by controller 605. In some embodiments, some of the components shown in FIG. 6 may be omitted. For example, memory 620 may be a non-volatile memory having the storage capacity of storage 630. Accordingly, although shown as a separate component, storage 630 may be embedded or included in memory 620.

Input devices 635 may be or may include a mouse, a keyboard, a touch screen or pad or any suitable input device. It will be recognized that any suitable number of input devices may be operatively connected to computing device 600 as shown by block 635. Output devices 645 may include one or more displays or monitors, speakers and/or any other suitable output devices. It will be recognized that any suitable number of output devices may be operatively connected to computing device 600 as shown by block 645. Any applicable input/output (I/O) devices may be connected to computing device 600 as shown by input devices 635 and output devices 645. For example, a wired or wireless network interface card (NIC), a printer, a universal serial bus (USB) device or external hard drive may be included in input devices 635 and/or output devices 645.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 620, computer-executable instructions such as executable code 625 and a controller such as controller 605.

The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 620 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 605), a plurality of input units, a plurality of output units, a plurality of memory units, and a plurality of storage units. A system according to some embodiments of the invention may additionally include other suitable hardware components and/or software components. In some embodiments, a system may include or may be, for example, a personal computer, a desktop computer, a laptop computer, a workstation, a server computer, a network device, or any other suitable computing device. For example, a system according to some embodiments of the invention as described herein may include one or more devices such as computing device 600.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus, certain embodiments may be combinations of features of multiple embodiments.

What is claimed is:

1. A method for calculating availability points for workforce scheduling, the method comprising:
obtaining past workloads per past time intervals;
calculating, for each future time interval of a set of future time intervals, a workforce requirement based on the past workloads;
obtaining, for each worker of a group of workers, an availability to work at the future time intervals;
calculating availability points for each of the future time intervals, based on the workforce requirement and the availability of each worker of the group of workers;
presenting the availability points per the future time intervals to each of the workers; and
obtaining desired time intervals from the workers.

2. The method of claim 1, wherein calculating the workforce requirement comprises calculating an expected requirement value (R) for the future time interval as an average number of workers that were required to work in at least one past time interval that is analogous to the future time interval.

3. The method of claim 2, wherein the past time interval that is analogous to the future time interval comprises past time intervals of a same time of day and day of week as the future time interval.

4. The method of claim 2, wherein calculating the availability points comprises:
for each future time interval:
calculating an expected staffing value (S) as the number of workers that were scheduled for the past time interval that is analogous to the future time interval;
calculating a net staffing (net_S) ratio as:
$$net\_S = \frac{S - R}{S + R}$$
calculating a level of interest (I) for the future time interval as a maximum value of one and the number of workers that declared their availability to work in the future time interval;
calculating an incentive factor (F) for the future time interval as:
$$F = \frac{R * net\_S}{I}$$
calculating an incentive factor range (range_F) as the difference between a maximum incentive factor across all the future time intervals (max_F) and a minimum incentive factor across all the future time intervals (min_F);
calculating the availability points (P) as:
$$P = A + \frac{F - min\_F}{range\_F} * B$$
where A and B are tuning parameters.

5. The method of claim 1, wherein the group of workers is a group of agents in a call center.

6. The method of claim 1, wherein the availability points per the future time intervals are presented to each of the workers in an application that enables the worker to enter desired time intervals based on the associated availability points.

7. The method of claim 1, comprising assigning agents to the future time intervals based on the desired time intervals and the future workforce requirement.

8. A method for calculating scores for a set of future time slots, the method comprising:
obtaining, for each future time slot of the set of future time slots, a number of agents required at an at least one equivalent past time slot;
calculating, for each of the future time slots, a number of agents required at the future time slot based on the number of agents required at the at least one equivalent past time slot;
obtaining, for each agent of a group of agents, an availability to work at the future time slots;
calculating the score for each of the future time slots, based on the number of agents required at the future time slot and the availability of each agent of the group of agents; and
presenting the scores per the future time slots to each of the agents.

9. The method of claim 8, wherein calculating the number of agents required at the future time slot comprises calculating an expected requirement value (R) for the future time interval as an average number of agents that were required at the at least one equivalent past time slot.

10. The method of claim 9, wherein calculating the scores comprises:
for each future time slot:
calculating an expected staffing value (S) as the number of agents that were scheduled for the past time slot that is equivalent to the future time slot;
calculating a net staffing (net_S) ratio as:
$$net\_S = \frac{S - R}{S + R}$$
calculating a level of interest (I) for the future time slot as a maximum value of one and the number of agents are available to work in the future time slot;
calculating an incentive factor (F) for the future time slot as:
$$F = \frac{R * net\_S}{I}$$
calculating an incentive factor range (range_F) as the difference between a maximum incentive factor across all the future time slots (max_F) and a minimum incentive factor across all the future time slots (min_F);
calculating the scores (P) as:
$$P = A + \frac{F - min\_F}{range\_F} * B$$
where A and B are tuning parameters.

11. The method of claim 8, wherein the group of agents is a group of agents in a call center.

12. The method of claim 8, wherein the scores per the future time slots are presented to each of the agents in an application that enables the agent to enter desired time slots based on the associated scores.

13. The method of claim 8, comprising assigning agents to the future time slots based on the desired time slots and the number of agents required at the future time slots.

14. The method of claim 8, wherein the at least one equivalent past time slot comprises past time slots of a same time of day and day of week as the future time slot.

15. A system for calculating availability points for workforce scheduling, the system comprising:
a memory; and
a processor configured to:
obtain past workloads per past time intervals;
calculate, for each future time interval of a set of future time intervals, a workforce requirement based on the past workloads;
obtain, for each worker of a group of workers, an availability to work at the future time intervals;
calculate availability points for each of the future time intervals, based on the workforce requirement and the availability of each worker of the group of workers;
present the availability points per the future time intervals to each of the workers; and
obtain desired time intervals from the workers.

16. The system of claim 13, wherein the processor is configured to calculate the workforce requirement by calculating an expected requirement value (R) for the future time interval as an average number of workers that were required to work in at least one past time interval that is analogous to the future time interval,
and wherein the processor is configured to calculate the availability points by:
for each future time interval:
calculating an expected staffing value (S) as the number of workers that were scheduled for the past time interval that is analogous to the future time interval;
calculating a net staffing (net_S) ratio as:
$$net\_S = \frac{S - R}{S + R}$$
calculating a level of interest (I) for the future time interval as a maximum value of one and the number of workers that declared their availability to work in the future time interval;
calculating an incentive factor (F) for the future time interval as:
$$F = \frac{R * net\_S}{I}$$
calculating an incentive factor range (range_F) as the difference between a maximum incentive factor across all the future time intervals (max_F) and a minimum incentive factor across all the future time intervals (min_F);
calculating the availability points (P) as:
$$P = A + \frac{F - min\_F}{range\_F} * B$$
where A and B are tuning parameters.

17. The system of claim 16, wherein the past time interval that is analogous to the future time interval comprises past time intervals of a same time of day and day of week as the future time interval.

18. The system of claim 15, wherein the group of workers is a group of agents in a call center.

19. The system of claim 15, wherein the availability points per the future time intervals are presented to each of the workers in an application that enables the worker to enter desired time intervals based on the associated availability points.

20. The system of claim 15, the processor is configured to assign agents to the future time intervals based on the desired time intervals and the future workforce requirement.
